(19) United States
(12) Patent Application Publication
(10) Pub. No.: US 2024/0176626 A1
(43) Pub. Date: May 30, 2024

(54) WALLPAPER DISPLAY METHOD AND APPARATUS AND ELECTRONIC DEVICE

(71) Applicant: VIVO MOBILE COMMUNICATION CO., LTD., Dongguan (CN)

(72) Inventors: Min AI, Dongguan (CN); Yi ZHOU, Dongguan (CN); Jinwei HU, Dongguan (CN)

(73) Assignee: VIVO MOBILE COMMUNICATION CO., LTD., Dongguan (CN)

(21) Appl. No.: 18/432,051

(22) Filed: Feb. 4, 2024

Related U.S. Application Data
(63) Continuation of application No. PCT/CN2022/112670, filed on Aug. 16, 2022.

(30) Foreign Application Priority Data
Aug. 18, 2021 (CN) 202110952128.8

(51) Int. Cl. G06F 9/451; G06F 3/01; G06F 11/30

(52) U.S. Cl. CPC G06F 9/451; G06F 3/011; G06F 11/3051

(57) ABSTRACT

A wallpaper display method and an electronic device are provided. The method includes: displaying a target wallpaper. The target wallpaper includes a scenario and an element. The method further includes obtaining a target parameter of an electronic device. The method also includes updating the scenario or the element in the target wallpaper when the target parameter changes. The target parameter includes at least one of system time, weather information, steps, battery level information, or a running state of an application of the electronic device.

### CROSS-REFERENCE TO RELATED APPLICATIONS

This application is a continuation of International Application No. PCT/CN2022/112670, filed on Aug. 16, 2022, which claims priority to Chinese Patent Application No. 202110952128.8, filed on Aug. 18, 2021. The entire contents of each of the above-referenced applications are expressly incorporated herein by reference.

### TECHNICAL FIELD

This application pertains to the technical field of electronic devices, and specifically, relates to a wallpaper display method and apparatus and an electronic device.

### BACKGROUND

Currently, in a process in which a user uses an electronic device, the user may set a system-owned wallpaper picture or a picture in an album as a wallpaper of the electronic device according to a preference of the user. Wallpapers are classified into a desktop wallpaper and a lock screen wallpaper. The user may separately set or simultaneously set the picture as a desktop wallpaper and a lock screen wallpaper.

In a related technology, when setting a wallpaper, the user generally sets an obtained still picture or dynamic picture as the wallpaper. However, after the user sets the wallpaper, a visual effect of the wallpaper is usually fixed, and a display effect is poor.

### SUMMARY

An objective of embodiments of this application is to provide a wallpaper display method and apparatus and an electronic device.

According to a first aspect, an embodiment of this application provides a wallpaper display method, and the method includes:
displaying a target wallpaper, where the target wallpaper includes a scenario and an element;
obtaining a target parameter of an electronic device; and
updating the scenario or the element in the target wallpaper in a case that the target parameter changes; where
the target parameter includes at least one of system time, weather information, steps, battery level information, and a running state of an application of the electronic device.

According to a second aspect, an embodiment of this application provides a wallpaper display apparatus, and the apparatus includes:
a display module, configured to display a target wallpaper, where the target wallpaper includes a scenario and an element;
an obtaining module, configured to obtain a target parameter of an electronic device; and
an updating module, configured to update the scenario or the element in the target wallpaper in a case that the target parameter changes; where
the target parameter includes at least one of system time, weather information, steps, battery level information, and a running state of an application of the electronic device.

According to a third aspect, an embodiment of this application provides an electronic device. The electronic device includes a processor, a memory, and a program or an instruction that is stored in the memory and that can be run on the processor, and when the program or the instruction is executed by the processor, steps of the method according to the first aspect are implemented.

According to a fourth aspect, an embodiment of this application provides a readable storage medium. The readable storage medium stores a program or an instruction, and when the program or the instruction is executed by a processor, steps of the method according to the first aspect are implemented.

According to a fifth aspect, an embodiment of this application provides a chip. The chip includes a processor and a communications interface, the communications interface is coupled to the processor, and the processor is configured to run a program or an instruction to implement the method according to the first aspect.

### BRIEF DESCRIPTION OF DRAWINGS

FIG. 1 is a flowchart of a wallpaper display method according to an embodiment of this application;

FIG. 2a to FIG. 2d are schematic diagrams of human-shaped elements in different postures according to an embodiment of this application;

FIG. 3 is a schematic diagram of a human-shaped element according to an embodiment of this application;

FIG. 4 is a schematic diagram of another human-shaped element according to an embodiment of this application;

FIG. 5 is a schematic diagram of a scenario in a target wallpaper according to an embodiment of this application;

FIG. 6 is a schematic diagram of another scenario in a target wallpaper according to an embodiment of this application;

FIG. 7 is a schematic diagram of still another scenario in a target wallpaper according to an embodiment of this application;

FIG. 8 is a schematic diagram of a structure of a wallpaper display apparatus according to an embodiment of this application;

FIG. 9 is a schematic diagram of a structure of an electronic device according to an embodiment of this application; and

FIG. 10 is a schematic diagram of a structure of another electronic device according to an embodiment of this application.

### DETAILED DESCRIPTION

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that data used in such a way are interchangeable in proper circumstances, so that the embodiments of this application can be implemented in an order other than the order illustrated or described herein. Objects classified by “first”, “second”, and the like are usually of a same type, and a quantity of objects is not limited. For example, there may be one or more first objects. In addition, in this specification and the claims, “and/or” represents at least one of connected objects, and a character “/” generally represents an “or” relationship between associated objects.

With reference to the accompanying drawings, a wallpaper display method provided in embodiments of this application is described in detail by using some embodiments and application scenarios thereof.

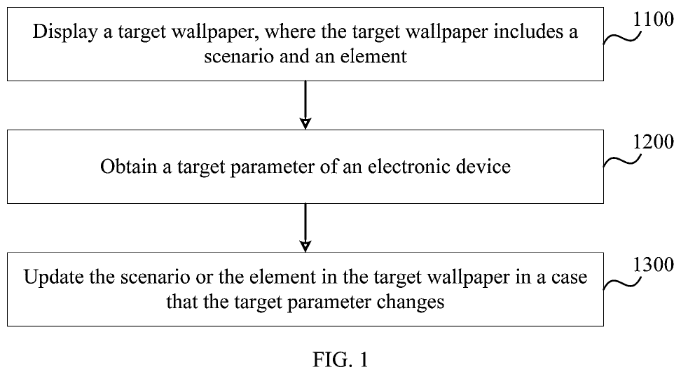

FIG. 1 is a flowchart of a wallpaper display method according to an embodiment of this application. The method may be applied to an electronic device, and the electronic device may be a mobile phone, a tablet computer, a notebook computer, or the like. As shown in FIG. 1, the method may include step 1100 to step 1300, and is described in detail below.

Step 1100: Display a target wallpaper, where the target wallpaper includes a scenario and an element.

The target wallpaper may be a desktop wallpaper, or the target wallpaper may be a lock screen wallpaper. The target wallpaper includes a scenario and an element, and both the scenario and the element are associated with a target parameter of an electronic device. The scenario and the element in the target wallpaper may be adjusted based on the target parameter of the electronic device.

For example, the scenario in the target wallpaper may be a background image whose display effect is adjustable in the target wallpaper. As another example, the scenario in the target wallpaper may be, for example, an effect layer whose display effect is adjustable in the target wallpaper, and the effect layer may be displayed on an upper layer of the target wallpaper.

For example, the element in the target wallpaper may be a part of elements whose display effect is adjustable in the target wallpaper, and the element may be, for example, a human-shaped element whose display effect is adjustable in the target wallpaper.

Step 1200: Obtain a target parameter of an electronic device.

The target parameter may include at least one of system time, weather information, steps, battery level information, and a running state of an application of the electronic device.

In this embodiment, the target parameter may include an environment-related parameter. For example, the target parameter may include system time, weather information, and the like. The system time may be a current time of a location of a user. The weather information may be current weather of the location of the user.

The target parameter may further include a parameter related to movement behavior of the user. For example, the target parameter may include steps.

The target parameter may further include a parameter related to a running state of the electronic device. For example, the target parameter may include battery level information and a running state of an application of the electronic device. The battery level information may be a current battery level of the electronic device. The running state of the application of the electronic device may be a running state of a preset application of the electronic device, and the preset application may be a sports application, a music application, or the like.

It should be noted that the target parameter may be set according to an actual requirement of the user. The target parameter includes but is not limited to the foregoing content. For example, the target parameter may further include ambient light, a heart rate of the user, and the like. This is not specially limited in this embodiment of this application.

Different target parameters are obtained in different manners. For example, when the target parameter includes weather information, real-time weather information may be obtained by using a weather application of the electronic device. For example, when the target parameter includes steps, steps of the user may be obtained in real time by using a sports application of the electronic device.

It may be understood that the target parameter may be a parameter collected by using the electronic device. For example, the target parameter may be obtained in real time by using the electronic device, or the target parameter may be obtained according to a period. This is not specially limited in this embodiment of this application. For example, because the weather information generally does not change in real time, in an implementation, the weather information may be obtained every hour.

Step 1300: Update the scenario or the element in the target wallpaper in a case that the target parameter changes.

In this embodiment of this application, a target wallpaper is displayed, where the target wallpaper includes a scenario and an element; a target parameter of an electronic device is obtained, where the target parameter includes at least one of system time, weather information, steps, battery level information, and a running state of an application of the electronic device; and the scenario or the element in the target wallpaper is updated in a case that the target parameter changes. In this way, the scenario and the element in the target wallpaper can be dynamically updated according to movement behavior of a user, environment information, and a running state of the electronic device, to improve a display effect of the wallpaper. In addition, the user can also visually view the movement behavior of the user, the environment information, and the running state of the electronic device by using the wallpaper, and this is convenient for the user.

In this embodiment, the updating the scenario or the element in the target wallpaper in a case that the target parameter changes may be: synchronously updating the scenario and the element in the target wallpaper in a case that the target parameter changes; or correspondingly updating and adjusting the scenario or the element in the target wallpaper in a case that the target parameter changes.

In some embodiments of this application, the target parameter includes a first parameter and a second parameter, and the updating the scenario or the element in the target wallpaper in a case that the target parameter changes may further include step 2100 and step 2200.

Step 2100: Update the scenario in the target wallpaper in a case that the first parameter changes, where the first parameter includes at least one of system time, weather information, and steps.

Step 2200: Update the element in the target wallpaper in a case that the second parameter changes, where the second parameter includes at least one of system time, steps, battery level information, and a running state of an application of the electronic device.

A process of updating the scenario or the element in the target wallpaper in a case that the target parameter changes is described below by using some embodiments.

In some embodiments of this application, the element is a human-shaped element, the second parameter includes steps and a running state of an application of the electronic device, and the updating the element in the target wallpaper in a case that the second parameter changes may further include step 3100 and step 3200.

Step 3100: Obtain change information of steps and a running state of a first application in a case that steps and the running state of the first application change.

The first application may be, for example, a sports application. The running state of the first application includes a state in which the first application is started. Starting the first application may be starting a motion monitoring function of the first application.

Step 3200: Update a posture of the human-shaped element based on the change information of steps and the running state of the first application, where the posture of the human-shaped element includes a standing posture, a sitting posture, a lying posture, and a flying posture.

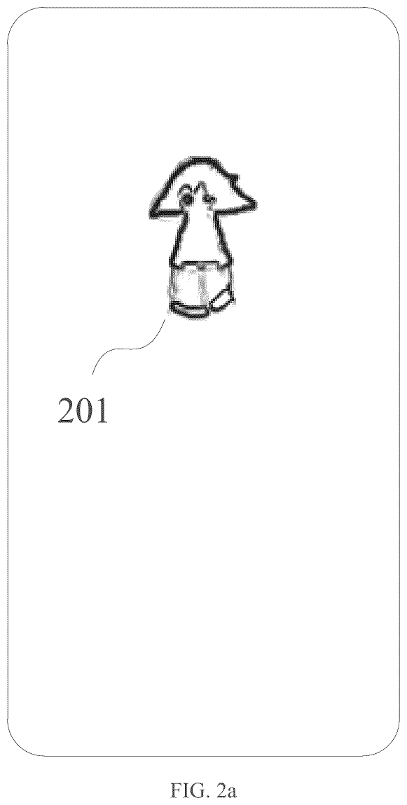

In this embodiment, the element included in the target wallpaper may be a human-shaped element. The figure element may be, for example, a human figure shown in FIG. 2a to FIG. 2d. FIG. 2a to FIG. 2d show four postures of the human-shaped element, for example, a standing posture, a sitting posture, a lying posture, and a flying posture.

In this embodiment, the posture of the human-shaped element is updated based on the change information of steps and the running state of the first application in a case that steps and the running state of the first application change, movement behavior of the user can be simulated by using the human-shaped element in the target wallpaper, thereby improving a display effect of the wallpaper.

In an example, the updating a posture of the human-shaped element based on the change information of steps and the running state of the first application may further include step 4100 to step 4400.

Step 4100: Update the posture of the human-shaped element to a standing posture in a case that steps change within first time.

The first time may be used to measure whether the user is in a standing posture. That steps of the user changes within the first time indicates that the user is in a standing posture. That steps of the user remains unchanged within the first time indicates that the user may be in a sitting posture or a lying posture. The first time may be, for example, 30 min. The first time may be set according to an actual situation of the user. This is not specially limited in this embodiment of this application.

Step 4200: Update the posture of the human-shaped element to a sitting posture in a case that steps remain unchanged within second time.

The second time may be used to measure whether the user is in a sitting posture. That steps of the user remains unchanged within the second time indicates that the user is in a sitting posture. The second time may be, for example, 30 min to 120 min. The second time may be set according to an actual situation of the user. This is not specially limited in this embodiment of this application.

Step 4300: Update the posture of the human-shaped element to a lying posture in a case that time in which steps remain unchanged is greater than or equal to third time.

The third time may be used to measure whether the user is in a sitting posture. That the time in which steps of the user remains unchanged exceeds the third time indicates that the user is in a lying posture. The third time may be, for example, 120 min. The third time may be set according to an actual situation of the user. This is not specially limited in this embodiment of this application.

Step 4400: Update the posture of the human-shaped element to a flying posture in a case that a first application is run.

The first application is a sports application. Starting the first application may include that the user turns on a motion monitoring function of the first application.

For example, as shown in FIG. 2a to FIG. 2d, steps of the user is obtained by using the electronic device. In a case that steps of the user increases within 30 min, a human-shaped element 201 in the target wallpaper is updated to a standing posture. In a case that steps of the user do not increase within 30 min to 120 min, the human-shaped element 201 in the target wallpaper is updated to a sitting posture. In a case that steps of the user do not increase after 120 min, the human-shaped element 201 in the target wallpaper is updated to a lying posture. In a case that the user turns on a motion monitoring function of the first application, for example, the user starts to run, the human-shaped element 201 in the target wallpaper is updated to a flying posture.

In some embodiments of this application, after the posture of the human-shaped element is updated based on the change information of steps and the running state of the first application, the method may further include: receiving a first input of the user for the human-shaped element; and displaying, in response to the first input, motion information corresponding to the posture of the human-shaped element.

The first input may be an input for obtaining the motion information. For example, the first input may be an input of tapping the human-shaped element. This is not specially limited in this embodiment of this application.

The motion information may be motion data of the user. For human-shaped elements of different postures, different motion information is obtained. For example, in a case that the posture of the human-shaped element is a standing posture, the motion information is information about steps of the user. For another example, in a case that the posture of the human-shaped element is a sitting posture, the motion information is information about duration in which the user is in a target posture, where the target posture is a posture corresponding to the posture of the human-shaped element. For another example, in a case that the posture of the human-shaped element is a lying posture, the motion information is information about remaining steps from target steps of the user, where the target steps are steps that need to be completed in preset time that is set by the user, and the information about the steps may be a difference between the target steps and current steps. For another example, in a case that the posture of the human-shaped element is a flying posture, the motion information is duration information and motion track information in which the user is in a moving state, where both motion duration and the motion track information may be obtained by using the first application.

It should be noted that the motion information may be set according to an actual requirement of the user, and specific information content of the motion information may include but is not limited to the foregoing information content.

In this embodiment, the posture of the human-shaped element in the target wallpaper is updated based on the change information of steps and the running state of the first application. A posture of the user can be simulated by using the human-shaped element, so that interest of wallpaper display can be increased. In addition, after the posture of the human-shaped element in the target wallpaper is updated based on the change information of steps and the running state of the first application, the user can quickly obtain the corresponding motion information by tapping the human-shaped element, and this is more convenient.

In some embodiments of this application, the element in the target wallpaper is a human-shaped element, the first parameter includes battery level information, and the updating the element in the target wallpaper in a case that the second parameter changes may further include: updating a display effect of the human-shaped element based on battery level information of the electronic device in a case that the electronic device is in a charging state.

In an implementation, whether the electronic device is in a charging state may be determined based on a connection state between the electronic device and a charging device.

For example, updating a display effect of the human-shaped element based on battery level information of the electronic device may be: displaying, on the human-shaped element, a light effect corresponding to the battery level information.

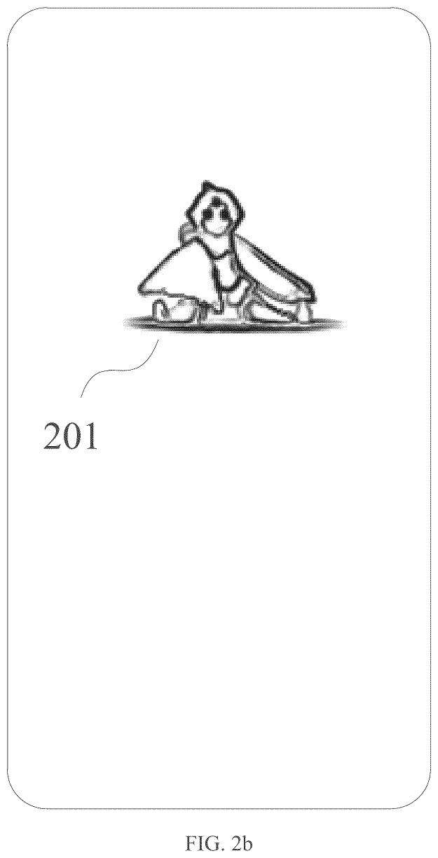

FIG. 3 is a schematic diagram of a human-shaped element according to an embodiment of this application. For example, a battery level information identifier 301 is displayed on a cloak of the human-shaped element, and the battery level information identifier 301 may represent a charging state of the electronic device.

For example, as shown in FIG. 3, five battery level information identifiers 301 are displayed on the cloak of the human-shaped element. When the electronic device is charged to 20%, the first battery level information identifier 301 is lit, a light band 302 is added to the second battery level information identifier 301, and remaining battery level information identifiers 301 are not lit. When the battery level of the electronic device is charged to 60%, the first three battery level information identifiers 301 are lit, a light band 302 is added to the fourth battery level information identifier 301, the remaining battery level information identifier 301 is not lit, and all the five battery level information identifiers 301 are lit until the battery level of the electronic device is charged to 100%.

In this embodiment, in a case that the electronic device is not in a charging state, a display effect corresponding to the battery level information is cancelled. That the electronic device is not in a charging state may be that the electronic device is charged to a full power state, or the electronic device is disconnected from the charging device.

In this embodiment, the display effect of the human-shaped element is updated based on battery level information of the electronic device. While the display effect of the wallpaper is enriched, the battery level information of the electronic device can be displayed by using the human-shaped element in the target wallpaper, so that it is convenient for the user to view a charging state of the electronic device. In addition, in a case that the electronic device is in a charging state, a display effect of the human-shaped element is updated based on the battery level information of the electronic device, and in a case that the electronic device is not in a charging state, a display effect of the human-shaped element corresponding to the battery level information is not updated, so that power consumption of the electronic device can be reduced, and a service life of the electronic device can be prolonged.

In some embodiments of this application, the second parameter includes a running state of an application of the electronic device, and the updating the element in the target wallpaper in a case that the second parameter changes may further include step 5100 and step 5200.

Step 5100: Obtain an application type of a second application in a case that the second application is run.

Running the second application may be running the second application on the background by the electronic device.

Step 5200: Display an identifier corresponding to the application type, where the identifier is adjacent to or at least partially overlaps the element.

In this embodiment, displaying the identifier corresponding to the application type may be displaying an identifier of the second application near the element in the target wallpaper, or displaying the identifier corresponding to the application type may be that the identifier corresponding to the application type of the second application partially overlaps the element.

Displaying the identifier corresponding to the application type of the second application on the target wallpaper may indicate that the electronic device is running the second application on the background.

There is a correspondence between the application type and the identifier. Different application types correspond to different identifiers. For example, if the second application is a music application, a corresponding identifier may be a headset or a sound box. For another example, if the second application is a navigation application, a corresponding identifier may be a navigation arrow. For another example, if the second application is a shared bicycle application, a corresponding identifier may be a bicycle. For another example, if the second application is a taxi taking application, a corresponding identifier may be a car. It should be noted that identifiers corresponding to different application types may be preset.

In an embodiment, the element in the target wallpaper is a human-shaped element, and in a case that the second application is a music application, a music identifier is displayed near the human-shaped element.

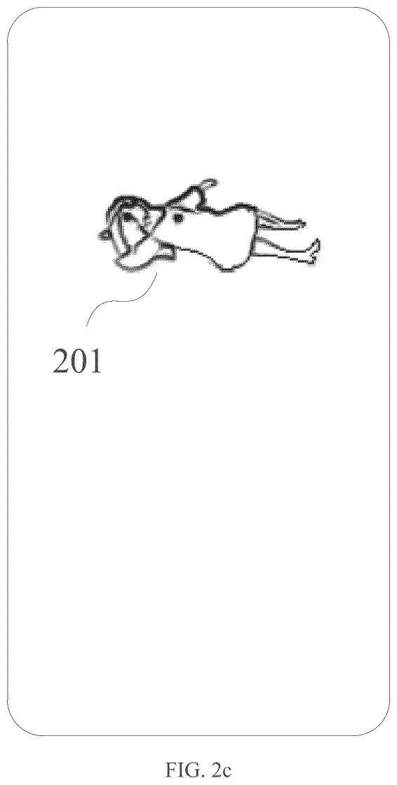

The music identifier may be, for example, a headset identifier shown in FIG. 4.

In this embodiment, in a case that the electronic device runs a music application, a music identifier is displayed near the human-shaped element in the target wallpaper. A scenario in which the user uses the music application may be simulated by using the human-shaped element in the target wallpaper. This is vivid and can further improve a display effect of the wallpaper.

In another embodiment, after the music identifier is displayed near the human-shaped element, the method may further include: receiving a second input of the user for the music identifier; and in response to the second input, controlling the second application to play music or pause playing music.

The second input may be an input used to control the second application. For example, the second input may be tap, double tap, or touch and hold. This is not specially limited in this embodiment of this application.

For example, FIG. 4 is a schematic diagram of another human-shaped element according to an embodiment of this application. In some embodiments, when the second application is run on the background of the electronic device, the headset identifier 401 is added to the human-shaped element, that is, a playback control is added to the human-shaped element. Then, the user may control, by tapping the headset identifier 401, the second application to play music or pause playing music.

In this embodiment, in a case that the electronic device runs a music application, a music identifier is displayed near the human-shaped element in the target wallpaper, and the user may control, by using the music identifier, the second application to play music. In this way, the user does not need to start the second application, and the second application can be controlled to play music. This is more convenient to use, and user experience is better.

In some embodiments of this application, the target parameter may include steps. The updating the scenario and the element in the target wallpaper in a case that the target parameter changes may further include: updating the target wallpaper in a case that steps change, where the updated target wallpaper includes a scenario and an element that are corresponding to steps.

In this embodiment, steps may be current steps of the user that are obtained by using a sports application of the electronic device. Different steps correspond to different scenarios and different elements.

In an implementation, target steps that are set by the user may be divided into multiple moving stages, and different moving stages correspond to different target wallpapers. Based on this, the target wallpaper may be updated based on a moving stage in which steps is located. For example, the user may set the target steps, and a process in which the user completes the target steps may correspond to a scenario in which a character A goes to an island B. The target steps may be divided into five moving stages. Different moving stages correspond to different landscapes, and a posture of the character A in each moving stage is also different.

In this embodiment, the target wallpaper may be updated based on steps of the user that is monitored in real time in a case that steps change, and a moving scenario of the user may be simulated as a game scenario or another specified scenario. In a case that steps of the user are reflected, a display effect of the wallpaper can be improved.

In some embodiments of this application, the target parameter includes system time, and the updating the scenario or the element in the target wallpaper in a case that the target parameter changes may further include step 6100 and step 6200.

Step 6100: Update a display parameter of the scenario or the element in a first manner in a case that the system time changes and the changed system time is in a first time period.

Step 6200: Update a display parameter of the scenario or the element in a second manner in a case that the system time changes and the changed system time is in a second time period.

It should be noted that, in a case that the system time changes, the scenario and the element in the target wallpaper may be updated according to the system time.

In this embodiment, the system time of the electronic device may be current time of a location of the user. In an implementation, a time zone in which the electronic device is located may be determined based on positioning information of the electronic device, that is, a time zone in which the user is located is determined, and corresponding time is obtained as the system time based on the time zone in which the user is located.

In this embodiment, one day may be divided into two time periods. A first time period may be a time period corresponding to daytime, for example, 6:00 to 19:00, and a second time period may be a time period corresponding to the night.

In some embodiments of this application, the method further includes: determining, based on positioning information of the electronic device or a third application, sunrise time and sunset time corresponding to a location of the user; and determining a first time period and a second time period based on the sunrise time and the sunset time, where the third application is a weather application.

In an implementation, the sunrise time and sunset time corresponding to the positioning information may be obtained by using the weather application based on the positioning information of the electronic device, and the first time period and the second time period are determined based on the sunrise time and the sunset time.

The display parameter includes at least one of dominant hue, contrast, saturation, brightness, and luminance.

For example, for the first time period (daytime), contrast, saturation, brightness, and luminance of a scenario picture are all high, and for the second time period (the night), contrast, saturation, brightness, and luminance of a scenario picture are all low.

For example, the updating a display parameter of the scenario and the element in a first manner in a case that the system time changes and the changed system time is in the first time period (daytime) is: adjusting dominant hue of a sky part of a scenario in a target wallpaper 501 to gradient white-blue, and increasing contrast, saturation, brightness, and luminance of an environment element such as cloud or grass in the scenario; and the updating a display parameter of the scenario and the element in a second manner in a case that the system time changes and the changed system is in the second time period (the night) is: adjusting dominant hue of a sky part of a scenario in a target wallpaper 601 to gradient blue-black, decreasing contrast, saturation, brightness, and luminance of an environment element such as cloud and grass in the scenario, and adding a light reflection effect a water surface in the scenario.

In this embodiment, the display parameter of the scenario and/or the element in the target wallpaper is updated based on the system time of the electronic device, so that a time change can be reflected by using the wallpaper. In addition, in a night time period, the display parameter of the scenario and/or the element in the target wallpaper is updated in the second manner, so that use of the user is prevented from being affected by excessive brightness of the electronic device, and user experience is better.

In some embodiments of this application, the first parameter includes weather information, and the updating the scenario in the target wallpaper in a case that the first parameter changes may further include step 7100 and step 7200.

Step 7100: Obtain target weather in a case that weather information changes.

The weather information may be current weather of the location of the user. For example, the target weather may be obtained based on positioning information of the electronic device or a third application, where the third application is a weather application.

Step 7200: Update a display effect of the scenario in the target wallpaper based on the target weather.

In an implementation, the updating a display effect of the scenario in the target wallpaper based on the target weather may be: superimposing an effect layer corresponding to the target weather on the target wallpaper.

The effect layer may be displayed on an upper layer of the target wallpaper. In other words, the target wallpaper may include multiple layers. An effect layer is displayed at an upper layer, and forms one part of the target wallpaper. A wallpaper that is customized by the user is displayed at a lower layer, and forms the other part of the target wallpaper. The two parts jointly constitute a visual effect of the target wallpaper.

The effect layer may correspond to the weather information. Different weather information corresponds to different visual effects of the effect layer. When the weather information changes, the target weather may be obtained, and an effect layer corresponding to the target weather is superposed on the target wallpaper.

In this embodiment, the second parameter includes weather information, and the updating the scenario in the target wallpaper in a case that the second parameter changes may further include: obtaining target weather in a case that the weather information changes; and updating a display effect of the element in the target wallpaper based on the target weather.

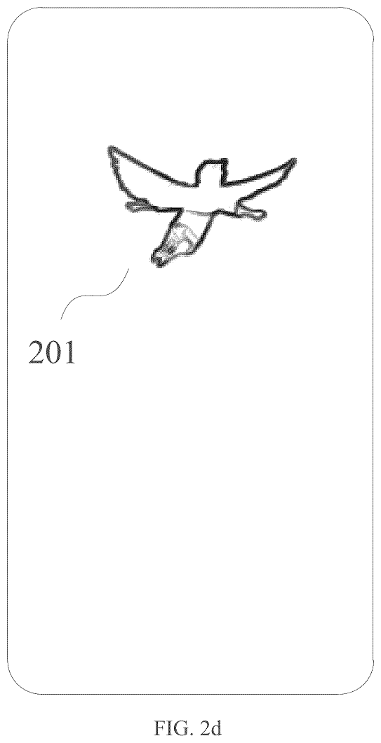

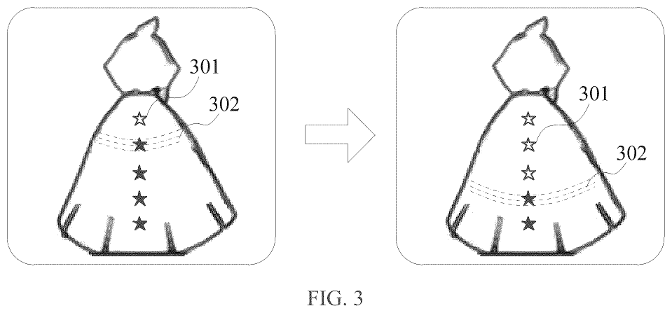

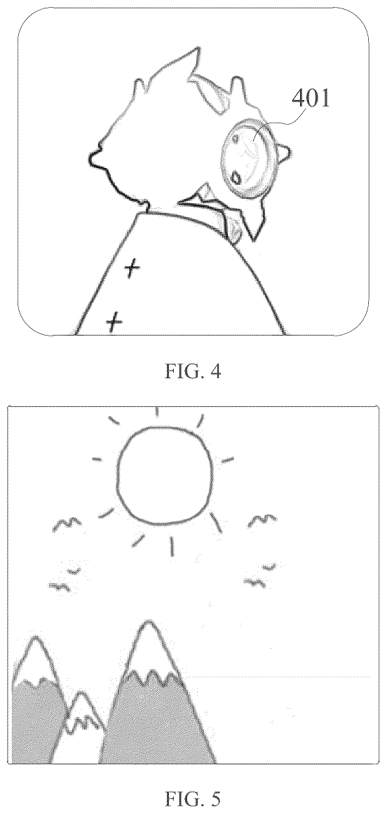

For example, as shown in FIG. 5, when the target weather is sunny, an effect layer corresponding to sunny is superposed on the target wallpaper, for example, a sun, cloud, and sunlight are added to the target wallpaper. For example, as shown in FIG. 6, when the target weather is rainy, an effect layer corresponding to rainy is superposed on the target wallpaper, for example, fog and rainwater are added to the target wallpaper, rainwear is added to the human-shaped element in the target wallpaper, and clarity of the target wallpaper is decreased. For example, as shown in FIG. 7, when the target weather is snowy, an effect layer corresponding to snowy is superposed on the target wallpaper, for example, snowflakes are added to the target wallpaper, cloth of the human-shaped element in the target wallpaper is changed, and brightness of a picture of the target wallpaper is increased, to reduce saturation of the picture of the target wallpaper.

In this embodiment, in a case that weather information changes, the display effect of the scenario in the target wallpaper is updated based on the target weather. In this way, a display effect of the wallpaper can be enriched, and in a case that a weather application does not need to be started, the weather information may be obtained by using the wallpaper.

In some embodiments of this application, the first parameter includes weather information, and the updating the scenario in the target wallpaper in a case that the first parameter changes may further include: receiving a third input of the user; obtaining target weather in response to the third input; and updating a display effect of the scenario in the target wallpaper based on the target weather.

The third input may be an input used to wake up the electronic device. The third input may be, for example, tapping a screen of the electronic device. This is not specially limited in this embodiment of this application.

In this embodiment, in response to the third input of the user, the target weather is determined based on the positioning information of the electronic device, and the display effect of the scenario in the target wallpaper is updated based on the target weather. The electronic device does not need to obtain the weather information in real time, thereby reducing power consumption of the electronic device.

It should be noted that, the wallpaper display method provided in this embodiment of this application may be performed by a wallpaper display apparatus or a control module that is in the wallpaper display apparatus and that is configured to perform the wallpaper display method. In this embodiment of this application, the wallpaper display apparatus provided in the embodiments of this application is described by using an example in which the wallpaper display method is performed by the wallpaper display apparatus.

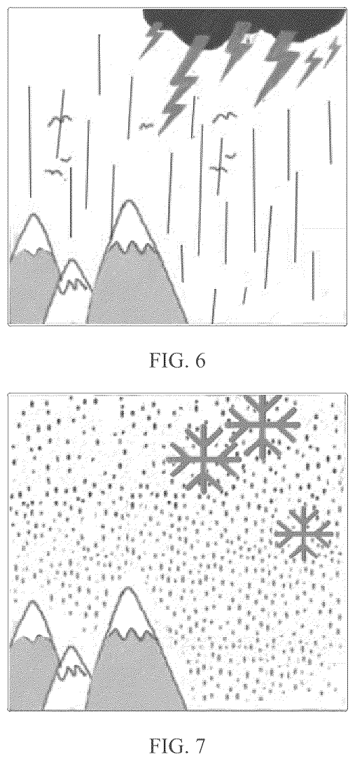

Corresponding to the foregoing embodiment, as shown in FIG. 8, an embodiment of this application further provides a wallpaper display apparatus 800. The wallpaper display apparatus 800 includes a display module 801, an obtaining module 802, and an updating module 803.

The display module 801 is configured to display a target wallpaper, where the target wallpaper includes a scenario and an element.

The obtaining module 802 is configured to obtain a target parameter of an electronic device.

The updating module 803 is configured to update the scenario or the element in the target wallpaper in a case that the target parameter changes.

The target parameter includes at least one of system time, weather information, steps, battery level information, and a running state of an application of the electronic device.

In some embodiments, the target parameter includes a first parameter and a second parameter, and the updating module includes: a first updating submodule, configured to update the scenario in the target wallpaper in a case that the first parameter changes, where the first parameter includes at least one of system time, weather information, and steps; and a second updating submodule, configured to update the element in the target wallpaper in a case that the second parameter changes, where the second parameter includes at least one of system time, steps, battery level information, and a running state of an application of the electronic device.

In some embodiments, the element is a human-shaped element, the second parameter includes steps and a running state of an application of the electronic device, and the second updating submodule includes: a first obtaining unit, configured to obtain change information of steps and a running state of a first application in a case that steps and the running state of the first application change; and a first updating unit, configured to update a posture of the human-shaped element based on the change information of steps and the running state of the first application, where the first application is a sports application, and the posture of the human-shaped element includes a standing posture, a sitting posture, a lying posture, and a flying posture.

In some embodiments, the first updating unit is configured to: update the posture of the human-shaped element to a standing posture in a case that steps change within first time; update the posture of the human-shaped element to a sitting posture in a case that steps remain unchanged within second time; update the posture of the human-shaped element to a lying state in a case that time in which steps remain unchanged is greater than or equal to third time; and update the posture of the human-shaped element to a flying posture in a case that the first application is run.

In some embodiments, the element is a human-shaped element, the second parameter includes battery level information, and the second updating submodule includes: a second updating unit, configured to update a display effect of the human-shaped element based on battery level information of the electronic device in a case that the electronic device is in a charging state.

In some embodiments, the second parameter includes a running state of an application of the electronic device, and the second updating submodule includes: a second obtaining unit, configured to obtain an application type of the second application in a case that the second application is run; and a display unit, configured to display an identifier corresponding to the application type, where the identifier is adjacent to or at least partially overlaps the element.

In some embodiments, the target parameter includes system time, and the updating module includes: a third updating submodule, configured to update a display parameter of the scenario or the element in a first manner in a case that the system time changes and the changed system time is in a first time period; and a fourth updating submodule, configured to update a display parameter of the scenario or the element in a second manner in a case that the system time changes and the changed system time is in a second time period; where the display parameter includes at least one of dominant hue, contrast, saturation, brightness, and luminance.

In some embodiments, the apparatus further includes a first determining module, configured to determine, based on positioning information of the electronic device or a third application, sunrise time and sunset time corresponding to a location of a user; and
a second determining module, configured to determine the first time period and the second time period based on the sunrise time and the sunset time, where the third application is a weather application.

In some embodiments, the first parameter includes weather information, and the first updating submodule includes: a third obtaining unit, configured to obtain target weather in a case that the weather information changes; and a third updating unit, configured to update a display effect of the scenario in the target wallpaper based on the target weather.

In this embodiment of this application, a target wallpaper is displayed, where the target wallpaper includes a scenario and an element; a target parameter of an electronic device is obtained, where the target parameter includes at least one of system time, weather information, steps, battery level information, and a running state of an application of the electronic device; and the scenario or the element in the target wallpaper is updated in a case that the target parameter changes. In this way, the scenario and the element in the target wallpaper can be dynamically updated according to movement behavior of a user, environment information, and a running state of the electronic device, to improve a display effect of the wallpaper. In addition, the user can also visually view the movement behavior of the user, the environment information, and the running state of the electronic device by using the wallpaper, and this is convenient for the user to use.

The wallpaper display apparatus in this embodiment of the application may be an apparatus, or a component, an integrated circuit, or a chip in a terminal. The apparatus may be a mobile electronic device, or may be a non-mobile electronic device. For example, the mobile electronic device may be a mobile phone, a tablet computer, a notebook computer, a palmtop computer, a vehicle-mounted electronic device, a wearable device, an Ultra-Mobile Personal Computer (UMPC), a netbook, or a Personal Digital Assistant (PDA), and the like. This is not specifically limited in the embodiments of this application.

The wallpaper display apparatus in the embodiments of this application may be an apparatus with an operating system. The operating system may be an Android operating system, an iOS operating system, or another possible operating system. This is not specifically limited in the embodiments of this application.

The wallpaper display apparatus provided in the embodiments of this application can implement the processes implemented in the method embodiment in FIG. 1. To avoid repetition, details are not described herein again.

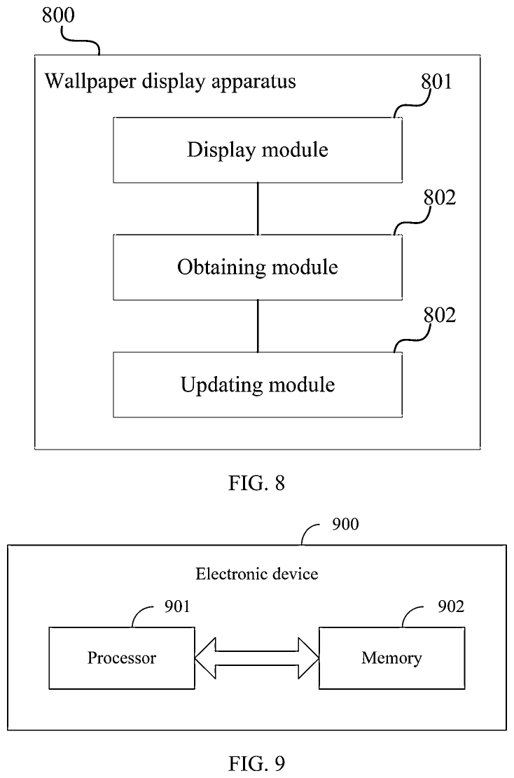

For example, as shown in FIG. 9, an embodiment of this application further provides an electronic device 900, including a processor 901, a memory 902, and a program or an instruction that is stored in the memory 902 and that can be run on the processor 901. When the program or the instruction is executed by the processor 901, the processes of the embodiments of the foregoing wallpaper display method are implemented, and a same technical effect can be achieved. To avoid repetition, details are not described herein again.

It should be noted that the electronic device in the embodiments of this application includes the foregoing mobile electronic device.

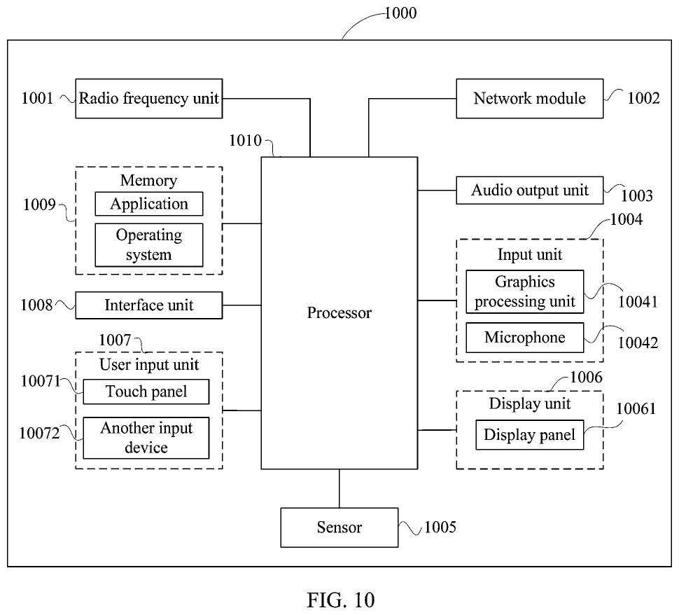

FIG. 10 is a schematic diagram of a hardware structure of an electronic device according to an embodiment of this application.

An electronic device 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the electronic device 1000 may further include a power supply (such as a battery) that supplies power to each component. The power supply may be logically connected to the processor 1010 by using a power supply management system, to implement functions such as charging and discharging management, and power consumption management by using the power supply management system. The structure of the electronic device shown in FIG. 10 does not constitute a limitation on the electronic device. The electronic device may include more or fewer components than those shown in the figure, a combination of some components, or different component arrangements. Details are not described herein.

The processor 1010 is configured to: display a target wallpaper by using the display unit 1006, where the target wallpaper includes a scenario and an element; obtain a target parameter of the electronic device; and update the scenario or the element in the target wallpaper in a case that the target parameter changes, where the target parameter includes at least one of system time, weather information, steps, battery level information, and a running state of an application of the electronic device.

For example, the target parameter includes a first parameter and a second parameter, and when updating the scenario or the element in the target wallpaper in a case that the target parameter changes, the processor 1010 is configured to: update the scenario in the target wallpaper in a case that the first parameter changes, where the first parameter includes at least one of system time, weather information, and steps; and update the element in the target wallpaper in a case that the second parameter changes, where the second parameter includes at least one of system time, steps, battery level information, and a running state of an application of the electronic device.

For example, the element is a human-shaped element, the second parameter includes steps and a running state of an application of the electronic device, and when updating the element in the target wallpaper in a case that the second parameter changes, the processor 1010 is configured to: obtain change information of steps and a running state of a first application in a case that steps and the running state of the first application change; and update a posture of the human-shaped element based on the change information of steps and the running state of the first application; where the first application is a sports application, and the posture of the human-shaped element includes a standing posture, a sitting posture, a lying posture, and a flying posture.

For example, when updating the posture of the human-shaped element based on the change information of steps and the running state of the first application, the processor 1010 is configured to: update the posture of the human-shaped element to a standing posture in a case that steps change within first time; update the posture of the human-shaped element to a sitting posture in a case that steps remain unchanged within second time; update the posture of the human-shaped element to a lying state in a case that time in which steps remain unchanged is greater than or equal to third time; and update the posture of the human-shaped element to a flying posture in a case that the first application is run.

For example, the element is a human-shaped element, the second parameter includes battery level information, and when updating the element in the target wallpaper in a case that the second parameter changes, the processor 1010 is configured to update a display effect of the human-shaped element based on battery level information of the electronic device in a case that the electronic device is in a charging state.

For example, the second parameter includes a running state of an application of the electronic device, and when updating the element in the target wallpaper in a case that the second parameter changes, the processor 1010 is configured to: obtain an application type of the second application in a case that the second application is run; and display an identifier corresponding to the application type by using the display unit 1006, where the identifier is adjacent to or at least partially overlaps the element.

For example, the target parameter includes system time, and when updating the scenario or the element in the target wallpaper in a case that the target parameter changes, the processor 1010 is configured to: update a display parameter of the scenario or the element in a first manner in a case that the system time changes and the changed system time is in a first time period; and update a display parameter of the scenario or the element in a second manner in a case that the system time changes and the changed system time is in a second time period; where the display parameter includes at least one of dominant hue, contrast, saturation, brightness, and luminance.

For example, before updating the display parameter of the scenario or the element in the first manner or updating the display parameter of the scenario or the element in the second manner, the processor 1010 is further configured to: determine, based on positioning information of the electronic device or a third application, sunrise time and sunset time corresponding to a location of a user; and determine the first time period and the second time period based on the sunrise time and the sunset time, where the third application is a weather application.

For example, the first parameter includes weather information, and when updating the scenario in the target wallpaper in a case that the first parameter changes, the processor 1010 is configured to: obtain target weather in a case that the weather information changes; and update a display effect of the scenario in the target wallpaper based on the target weather.

In this embodiment of this application, a target wallpaper is displayed, where the target wallpaper includes a scenario and an element; a target parameter of an electronic device is obtained, where the target parameter includes at least one of system time, weather information, steps, battery level information, and a running state of an application of the electronic device; and the scenario or the element in the target wallpaper is updated in a case that the target parameter changes. In this way, the scenario and the element in the target wallpaper can be dynamically updated according to movement behavior of a user, environment information, and a running state of the electronic device, to improve a display effect of the wallpaper. In addition, the user can also visually view the movement behavior of the user, the environment information, and the running state of the electronic device by using the wallpaper, and this is convenient for the user to use.

It should be understood that, in this embodiment of this application, the input unit 1004 may include a Graphics Processing Unit (GPU) 10041 and a microphone 10042, and the graphics processing unit 10041 processes image data of a still picture or a video obtained by an image capture apparatus (such as a camera) in a video capture mode or an image capture mode. The display unit 1006 may include a display panel 10061. For example, the display panel 10061 may be configured in a form such as a liquid crystal display or an organic light-emitting diode. The user input unit 1007 includes a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein. The memory 1009 may be configured to store a software program and various data, including but not limited to an application program and an operating system. An application processor and a modem processor may be integrated into the processor 1010, the application processor mainly processes an operating system, a user interface, an application program, and the like, and the modem processor mainly processes wireless communication. It can be understood that, in some alternative embodiments, the modem processor may not be integrated into the processor 1010.

An embodiment of this application further provides a readable storage medium. The readable storage medium stores a program or an instruction. When the program or the instruction is executed by a processor, the processes in the foregoing embodiments of the wallpaper display method are implemented, and a same technical effect can be achieved. To avoid repetition, details are not described herein again.

The processor is a processor in the electronic device in the foregoing embodiment. The readable storage medium includes a computer-readable storage medium such as a Read-Only Memory (ROM), a Random Access Memory (RAM), a magnetic disk, an optical disc, or the like.

An embodiment of this application further provides a chip. The chip includes a processor and a communications interface, and the communications interface is coupled to the processor. The processor is configured to run a program or an instruction, to implement various processes of the foregoing embodiments of the wallpaper display method, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In the absence of more restrictions, an element defined by the statement “including a . . . ” does not exclude another same element in a process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, those of ordinary skill in the art can make many forms without departing from the purpose of this application and the protection scope of the claims, all of which fall within the protection of this application.

1. A wallpaper display method, comprising:
displaying a target wallpaper, wherein the target wallpaper comprises a scenario and an element;
obtaining a target parameter of an electronic device; and
updating the scenario or the element in the target wallpaper when the target parameter changes, wherein
the target parameter comprises at least one of system time, weather information, steps, battery level information, or a running state of an application of the electronic device.

2. The wallpaper display method according to claim 1, wherein the target parameter comprises a first parameter and a second parameter, and the updating the scenario or the element in the target wallpaper when the target parameter changes comprises:
updating the scenario in the target wallpaper when the first parameter changes, wherein the first parameter comprises at least one of system time, weather information, or steps, and
updating the element in the target wallpaper when the second parameter changes, wherein the second parameter comprises at least one of system time, steps, battery level information, or a running state of an application of the electronic device.

3. The wallpaper display method according to claim 2, wherein the element is a human-shaped element, the second parameter comprises steps and a running state of an application of the electronic device, and the updating the element in the target wallpaper when the second parameter changes comprises:
obtaining change information of steps and a running state of a first application when steps and the running state of the first application change; and
updating a posture of the human-shaped element based on the change information of steps and the running state of the first application, wherein
the first application is a sports application, and the posture of the human-shaped element comprises a standing posture, a sitting posture, a lying posture, or a flying posture.

4. The wallpaper display method according to claim 3, wherein the updating a posture of the human-shaped element based on the change information of steps and the running state of the first application comprises:
updating the posture of the human-shaped element to the standing posture when steps change within first time;
updating the posture of the human-shaped element to the sitting posture when steps remain unchanged within second time;
updating the posture of the human-shaped element to the lying posture when time in which steps remain unchanged is greater than or equal to third time; and
updating the posture of the human-shaped element to the flying state when the first application is run.

5. The wallpaper display method according to claim 2, wherein the element is a human-shaped element, the second parameter comprises battery level information, and the updating the element in the target wallpaper when the second parameter changes comprises:
updating a display effect of the human-shaped element based on battery level information of the electronic device when the electronic device is in a charging state.

6. The wallpaper display method according to claim 2, wherein the second parameter comprises a running state of an application of the electronic device, and the updating the element in the target wallpaper when the second parameter changes comprises:
obtaining an application type of the second application when the second application is run; and
displaying an identifier corresponding to the application type, wherein the identifier is adjacent to or at least partially overlaps the element.

7. The wallpaper display method according to claim 1, wherein the target parameter comprises system time, and the updating the scenario or the element in the target wallpaper when the target parameter changes comprises:
updating a display parameter of the scenario or the element in a first manner when the system time changes and the changed system time is in a first time period; and
updating a display parameter of the scenario or the element in a second manner when the system time changes and the changed system time is in a second time period, wherein
the display parameter comprises at least one of dominant hue, contrast, saturation, brightness, or luminance.

8. The wallpaper display method according to claim 7, wherein before the updating a display parameter of the scenario or the element in a first manner or updating a display parameter of the scenario or the element in a second manner, the method further comprises:
determining, based on positioning information of the electronic device or a third application, sunrise time and sunset time corresponding to a location of a user; and
determining the first time period and the second time period based on the sunrise time and the sunset time, wherein
the third application is a weather application.

9. The wallpaper display method according to claim 2, wherein the first parameter comprises weather information, and the updating the scenario in the target wallpaper when the first parameter changes comprises:
obtaining target weather when the weather information changes; and
updating a display effect of the scenario in the target wallpaper based on the target weather.

10. An electronic device, comprising a processor; and a memory having a computer program or an instruction stored thereon, wherein the computer program or the instruction, when executed by the processor, causes the processor to perform operations comprising:
displaying a target wallpaper, wherein the target wallpaper comprises a scenario and an element;
obtaining a target parameter of the electronic device; and
updating the scenario or the element in the target wallpaper when the target parameter changes, wherein
the target parameter comprises at least one of system time, weather information, steps, battery level information, or a running state of an application of the electronic device.

11. The electronic device according to claim 10, wherein the target parameter comprises a first parameter and a second parameter, and the updating the scenario or the element in the target wallpaper when the target parameter changes comprises:
updating the scenario in the target wallpaper when the first parameter changes, wherein the first parameter comprises at least one of system time, weather information, or steps, and
updating the element in the target wallpaper when the second parameter changes, wherein the second parameter comprises at least one of system time, steps, battery level information, or a running state of an application of the electronic device.

12. The electronic device according to claim 11, wherein the element is a human-shaped element, the second parameter comprises steps and a running state of an application of the electronic device, and the updating the element in the target wallpaper when the second parameter changes comprises:
obtaining change information of steps and a running state of a first application when steps and the running state of the first application change; and
updating a posture of the human-shaped element based on the change information of steps and the running state of the first application, wherein
the first application is a sports application, and the posture of the human-shaped element comprises a standing posture, a sitting posture, a lying posture, or a flying posture.

13. The electronic device according to claim 12, wherein the updating a posture of the human-shaped element based on the change information of steps and the running state of the first application comprises:
updating the posture of the human-shaped element to the standing posture when steps change within first time;
updating the posture of the human-shaped element to the sitting posture when steps remain unchanged within second time;
updating the posture of the human-shaped element to the lying posture when time in which steps remain unchanged is greater than or equal to third time; and
updating the posture of the human-shaped element to the flying state when the first application is run.

14. The electronic device according to claim 11, wherein the element is a human-shaped element, the second parameter comprises battery level information, and the updating the element in the target wallpaper when the second parameter changes comprises:
updating a display effect of the human-shaped element based on battery level information of the electronic device when the electronic device is in a charging state.

15. The electronic device according to claim 11, wherein the second parameter comprises a running state of an application of the electronic device, and the updating the element in the target wallpaper when the second parameter changes comprises:
obtaining an application type of the second application when the second application is run; and
displaying an identifier corresponding to the application type, wherein the identifier is adjacent to or at least partially overlaps the element.

16. The electronic device according to claim 10, wherein the target parameter comprises system time, and the updating the scenario or the element in the target wallpaper when the target parameter changes comprises:
updating a display parameter of the scenario or the element in a first manner when the system time changes and the changed system time is in a first time period; and
updating a display parameter of the scenario or the element in a second manner when the system time changes and the changed system time is in a second time period, wherein
the display parameter comprises at least one of dominant hue, contrast, saturation, brightness, or luminance.

17. The electronic device according to claim 16, wherein before the updating a display parameter of the scenario or the element in a first manner or updating a display parameter of the scenario or the element in a second manner, the operations further comprise:
determining, based on positioning information of the electronic device or a third application, sunrise time and sunset time corresponding to a location of a user; and
determining the first time period and the second time period based on the sunrise time and the sunset time, wherein
the third application is a weather application.

18. The electronic device according to claim 11, wherein the first parameter comprises weather information, and the updating the scenario in the target wallpaper when the first parameter changes comprises:
obtaining target weather when the weather information changes; and
updating a display effect of the scenario in the target wallpaper based on the target weather.

19. A non-transitory readable storage medium, storing a computer program or an instruction that, when executed by a processor, causes the processor to perform operations comprising:
displaying a target wallpaper, wherein the target wallpaper comprises a scenario and an element;
obtaining a target parameter of an electronic device; and
updating the scenario or the element in the target wallpaper when the target parameter changes, wherein
the target parameter comprises at least one of system time, weather information, steps, battery level information, or a running state of an application of the electronic device.

20. The non-transitory readable storage medium according to claim 19, wherein the target parameter comprises a first parameter and a second parameter, and the updating the scenario or the element in the target wallpaper when the target parameter changes comprises:
updating the scenario in the target wallpaper when the first parameter changes, wherein the first parameter comprises at least one of system time, weather information, or steps, and
updating the element in the target wallpaper when the second parameter changes, wherein the second parameter comprises at least one of system time, steps, battery level information, or a running state of an application of the electronic device.
